(19) United States
(12) Patent Application Publication
(10) Pub. No.: US 2016/0105034 A1
(43) Pub. Date: Apr. 14, 2016

(54) DEVICE FOR CHIP-TO-CHIP WIRELESS POWER TRANSMISSION USING OSCILLATOR

(71) Applicant: SOONGSIL UNIVERSITY RESEARCH CONSORTIUM TECHNO-PARK, Seoul (KR)

(72) Inventors: Mi Lim LEE, Yangju-si (KR); Chang Kun Park, Gwangmyeong-si (KR)

(21) Appl. No.: 14/676,831

(22) Filed: Apr. 2, 2015

(30) Foreign Application Priority Data
Oct. 14, 2014 (KR) 10-2014-0138236

(51) Int. Cl. H02J 5/00

(52) U.S. Cl. CPC H02J 5/005

(57) ABSTRACT

Disclosed is a device for chip-to-chip wireless power transmission. The device includes: a first transistor that outputs a first output signal; a second transistor that outputs a second output signal having a phase opposite to that of the first output signal; capacitors that each have a first terminal and a second terminal connected the first transistor and the second transistor, respectively; and a transmitting coil that wirelessly transmits AC power outputted through the first and second transistors to a receiving coil of a power receiver.

### CROSS-REFERENCE TO RELATED APPLICATIONS

This application claims the priority of Korean Patent Application No. 10-2014-0138236 filed on Oct. 14, 2014, in the Korean Intellectual Property Office, the disclosure of which is incorporated herein by reference.

### BACKGROUND OF THE INVENTION

1. Field of the Invention

The present invention relates to a device for chip-to-chip wireless power transmission using an oscillator, and more particularly, to a device for chip-to-chip wireless power transmission using an oscillator which can use an oscillator as a wireless power transmitter in a stacked structure for supplying power to chips.

2. Description of the Related Art

Recently, a study of 3D semiconductor technology for stacking a plurality of chips to reduce the area of an integrated circuit in the process of designing has been conducted. According to a TSV (Through Silicon Via), which is a typical one, communication between chips is made by a via and a bump, unlike the existing MCP (Multi-Chip Package).

However, according to TSV, since the via is formed by forming a physical hole in a chip and filing the hole with a metallic material, there is a problem in that the research/development and commercialization costs increase due to the additional semiconductor process. Further, it takes much effort to increase the yield ratio of the via due to a problem like cracks. The TSV technology results in an increase in manufacturing cost.

In order to solve those problems, recently, a technology of chip-to-chip wireless communication has been intensively studied. FIG. 1 is a view illustrating the concept of a chip-to-chip wireless communication technology according to the related art. Communication between the stacked chips is made by inductive coupling generated by inductor-typed pads.

The technology of chip-to-chip wireless communication is considered as the next generation 3D semiconductor technology. However, it is the largest problem of the wireless communication that it is difficult to supply power to chips. In particular, a chip for transmitting power to achieve chip-to-chip wireless communication requires a circuit for converting DC power into AC power. FIG. 2 illustrates atypical configuration of a transmitter for chip-to-chip wireless power transmission.

In FIG. 2, a power transmitter is composed of an oscillator, a DC-AC converter, and a transmitting coil. The DC-AC converter converts DC power voltage into AC power that can be wirelessly transmitted. The oscillator turns on/off a switch in the DC-AC converter. The transmitting coil wirelessly transmits AC power generated by the DC-AC converter.

In FIG. 2, a power receiver is composed of a receiving coil, a rectifier, and a DC-DC converter. The receiving coil wirelessly receives AC power from the transmitting coil. The rectifier converts AC power into DC power. The DC-DC converter converts DC power from the rectifier into a voltage suitable for an inner circuit of a chip that receives the DC power. As described above, the DC-AC converter can be considered as a very important circuit block in the power transmitter.

FIG. 3 is diagrams illustrating the DC-AC converter of FIG. 2 in more detail. (a) of FIG. 3 is a diagram illustrating only the power transmitter composed of the oscillator, the DC-AC converter, and the transmitting coil. (b) of FIG. 3 illustrates a DC-AC converter implemented in a Class-E type, as an example of the DC-AC converter shown in (a) of FIG. 3. Obviously, another type of DC-AC converter instead of the Class-E type may be used.

Referring to (b) of FIG. 3, an AC signal from an oscillator is input to two transistors of the Class-E type DC-AC converter. In the Class-E type, the transistors convert DC power from a VDD into AC power by being turned on/off in response to signals from an oscillator. An inductor L1 between the VDD and the transistors is a necessary device for conversion from DC power into AC power in the Class-E. AC power converted as described above is wirelessly transmitted through a transmitting coil L2 connected to output nodes of the transistors in the Class-E.

The configuration of the power transmitter of the related art is used as a circuit that necessarily requires an oscillator, a DC-AC converter, and a transmitting coil. However, a chip-to-chip wireless power transmission system has a problem in that as the size and the number of necessary circuits is increased, so the manufacturing cost is increased.

The background of the present invention has been disclosed in Korean Patent No. 1392888 (2014 May 8).

### SUMMARY OF THE INVENTION

An aspect of the present invention provides a device for chip-to-chip wireless power transmission using an oscillator which can reduce the size of a circuit and increase power conversion efficiency.

According to an aspect of the present invention, there is provided a device for chip-to-chip wireless power transmission, which is provided to a power transmitter. The device includes: a first transistor that has a first terminal connected to a first power and outputs a first output signal through a second terminal; a second transistor that has a first terminal connected to the first power, a second terminal connected to a gate of the first transistor, and a gate connected to the second terminal of the first transistor, and outputs a second output signal having a phase opposite to that of the first output signal through the second terminal; capacitors that each have a first terminal and a second terminal connected to the second terminal of the first transistor and the second terminal of the second transistor, respectively; and a transmitting coil that has a first terminal and a second terminal connected to the second terminal of the first transistor and the second terminal of the second transistor, respectively, a third terminal connected to a second power, and wirelessly transmits AC power outputted through the first and second transistor to a receiving coil of a power receiver.

The transmitting coil and the receiving coil may be a first transmitting coil and a first receiving coil, the device may further include at least one second transmitting coil that has a first and a second terminal connected in parallel between the first terminal and the second terminal of the first transmitting coil, and a third terminal connected to the second power, respectively, and at least one second transmitting coil may wirelessly transmit the AC power to at least one second receiving coil corresponding to at least one power receiver, respectively.

According to another aspect of the present invention, there is provided a device for chip-to-chip wireless power transmission, which is provided to a power transmitter. The device includes: a first transistor that has a first terminal connected to a first power and outputs a first output signal through a second terminal; a second transistor that has a first terminal connected to the first power, a second terminal connected to a gate of the first transistor, and a gate connected to the second terminal of the first transistor, and outputs a second output signal having a phase opposite to that of the first output signal through the second terminal; capacitors that each have a first terminal and a second terminal connected to the second terminal of the first transistor and the second terminal of the second transistor, respectively; and a coil transmitter that has N transmitting coils connected in series, in which a first terminal of a first transmitting coil and a second terminal of an N-th transmitting coil are connected to the second terminal of the first transistor and the second terminal of the second transistor, respectively, and a second power is connected to one node selected from at least one node formed between the transmitting coils, in which the N transmitting coils wirelessly transmit AC power outputted through the first and second transistors to N receiving coils corresponding to N power receivers, respectively.

According to another aspect of the present invention, there is provided a device for chip-to-chip wireless power transmission, which is provided to a power transmitter. The device includes: a first transistor that has a first terminal connected to a first power and outputs a first output signal through a second terminal; a second transistor that has a first terminal connected to the first power, a second terminal connected to a gate of the first transistor, and a gate connected to the second terminal of the first transistor, and outputs a second output signal having a phase opposite to that of the first output signal through the second terminal; a coil transmitter that has N transmitting coils connected in series, in which a first terminal of a first transmitting coil and a second terminal of an N-th transmitting coil are connected to the second terminal of the first transistor and the second terminal of the second transistor, respectively, and a second power is connected to one node selected from at least one node formed between the transmitting coils; and N capacitors that are connected in parallel to the N transmitting coils, respectively, in which the N transmitting coils wirelessly transmit AC power outputted through the first and second transistors to N receiving coils corresponding to N power receivers, respectively.

The N may be an even number and the second power may be connected to a node at the center of at least one node formed between the transmitting coils.

The first power may be a grounding power and the second power may be larger than the first power.

The device may further include: a first capacitor connected between the second terminal of the first transistor and the gate of the second transistor; and a second capacitor connected between the second terminal of the second transistor and the gate of the first transistor.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating the concept of a chip-to-chip wireless communication technology according to the related art;

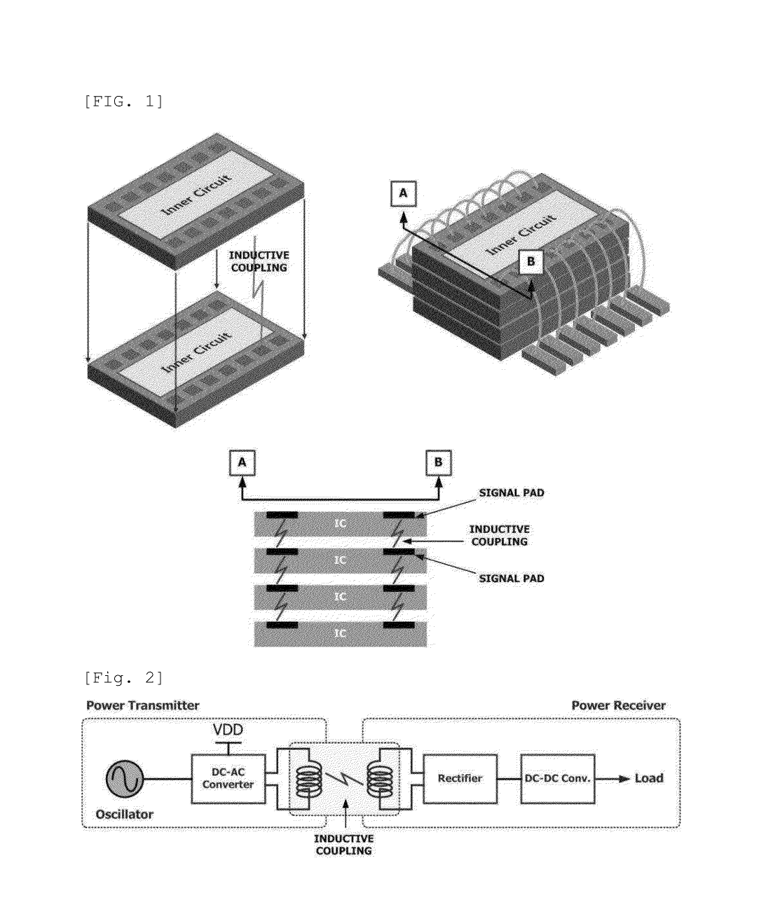

FIG. 2 is a diagram illustrating a typical configuration of a transmitter for chip-to-chip wireless power transmission;

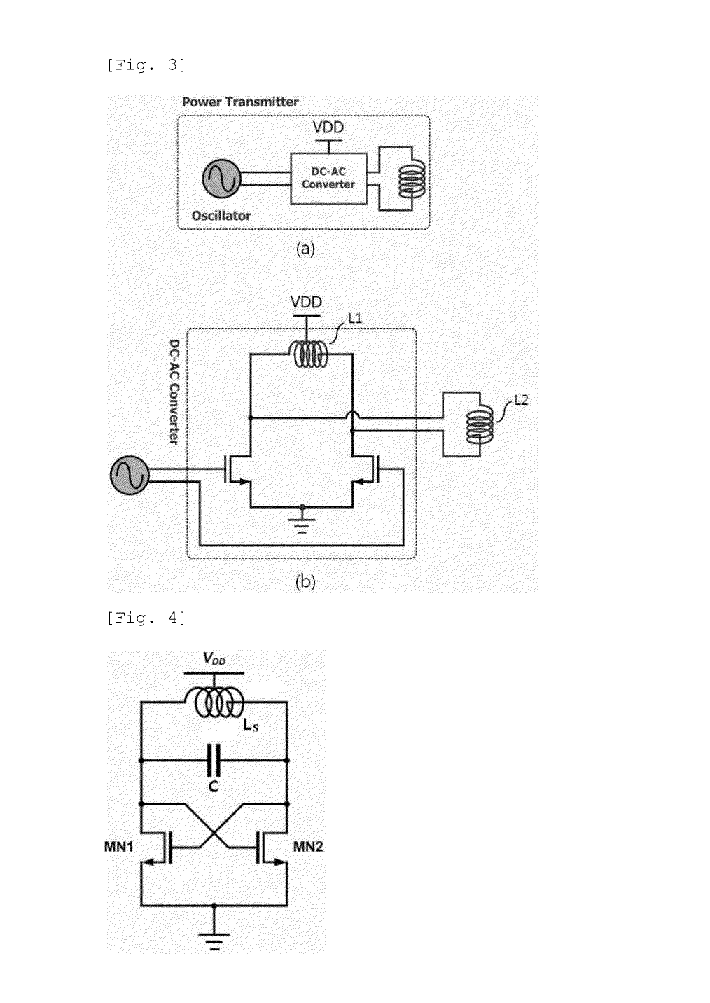

FIG. 3 is diagrams illustrating the DC-AC converter of FIG. 2 in more detail;

FIG. 4 is a diagram illustrating the configuration of a device for a chip-to-chip wireless power transmission according to a first embodiment of the present invention;

FIG. 5 is a diagram illustrating the configuration of a power transmitter equipped with the device of FIG. 4;

FIGS. 6 to 8 are modifications of FIG. 5;

FIG. 9 is a diagram illustrating the configuration of a power transmitter equipped with a device for chip-to-chip wireless power transmission according to a second embodiment of the present invention;

FIGS. 10 and 11 are modifications of FIG. 9; and

FIG. 12 is a diagram illustrating the configuration of a power transmitter equipped with a device for chip-to-chip wireless power transmission according to a third embodiment of the present invention.

### DETAILED DESCRIPTION OF THE PREFERRED EMBODIMENT

Exemplary embodiments of the present invention will now be described in detail with reference to the accompanying drawings.

Hereinafter, embodiments of the present invention will be described in detail with reference to the accompanying drawings for those skilled in the art to be able to easily accomplish the present invention. However, as those skilled in the art would realize, the described embodiments may be modified in various different ways, all without departing from the spirit or scope of the present invention. In the accompanying drawings, portions not related to the description will be omitted in order to obviously describe the present invention, and similar reference numerals will be used to describe similar portions throughout the present specification.

Throughout the specification, it should be understood that when one element is referred to as being “connected to” another element, it may be “connected directly to” another element or “connected electrically to’ another element, with the other element therebetween. Further, unless explicitly described otherwise, “comprising” any components will be understood to imply the inclusion of other components rather than the exclusion of any other components.

The present invention relates to a device for chip-to-chip wireless power transmission using an oscillator, in which, for a power transmitter for chip-to-chip wireless power transmission, an oscillator with an LC tank, not an existing DC-AC converter, is used and an inductor of the oscillator is used as a transmitting coil for wireless power transmission. Therefore, according to embodiments of the present invention, a transmitter is less complicated, the area of an integrated circuit for a DC-AC converter is reduced, and the entire power conversion efficiency of the transmitter is increased.

In wireless power transmission between stacked chips, a power transmitter may be included in a first chip and a power receiver corresponding to the power transmitter may be included in at least one second chip. Obviously, the present invention is not limited to this configuration.

In embodiments of the present invention, a power transmitter has the type of an oscillator and the oscillator may be implemented in various types. In the following embodiments, it is assumed that oscillators have a cross-coupled structure and transistors are N-type transistors. Obviously, the present invention is not limited to those examples.

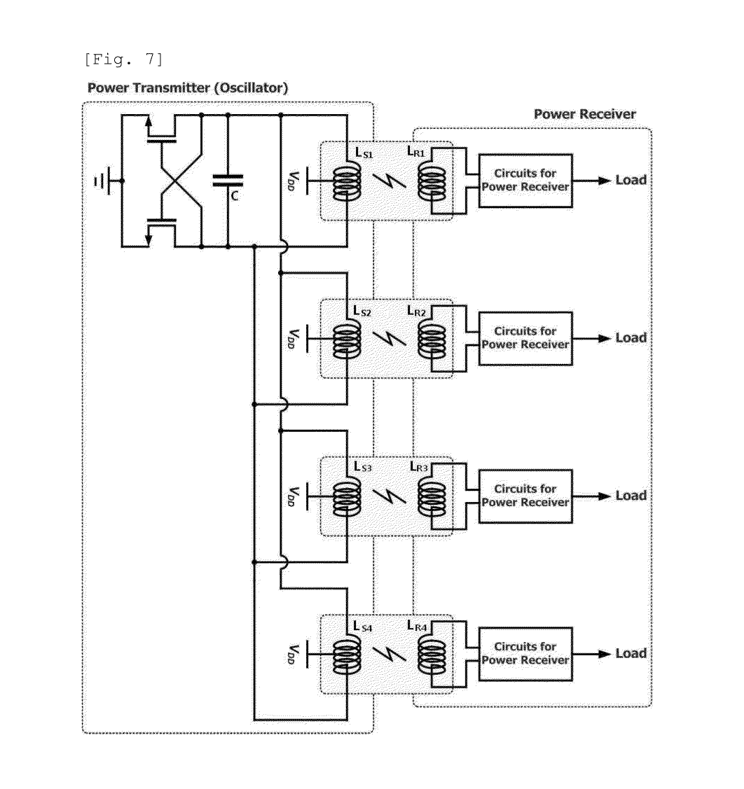

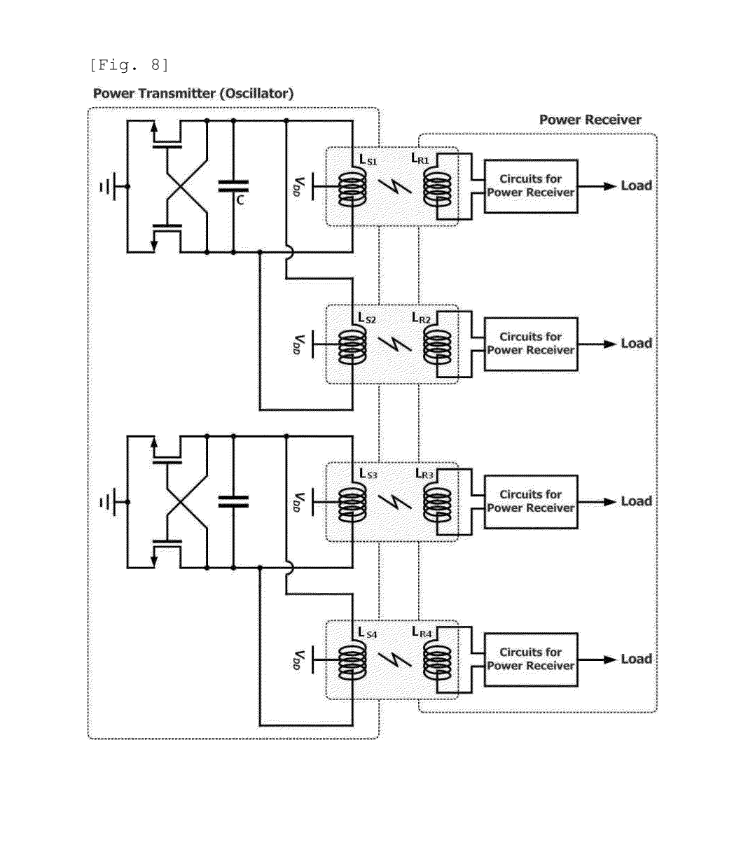

Hereafter, embodiments of the present invention are described in detail. FIG. 4 is a diagram illustrating the configuration of an apparatus for a chip-to-chip wireless power transmission according to a first embodiment of the present invention. FIG. 5 is a diagram illustrating the configuration of a power transmitter equipped with the device of FIG. 4.

In detail, a device for a chip-to-chip wireless power transmission according to a first embodiment of the present invention includes a first transistor MN1, a second transistor MN2, a capacitor C, and a transmitting coil L_{S}.

The first transistor MN1 has a first terminal connected to a first power (for example, GND) and outputs a first output signal (positive output) through a second terminal.

The second transistor MN2 has a first terminal connected to the first power (for example, GND), a second terminal connected to a gate of the first transistor MN1, and a gate connected to the second terminal of the first transistor MN1, so it is cross-coupled to the first transistor MN1. The second transistor MN2 outputs a second output signal (negative output) with a phase opposite to that of the first output signal through the second terminal.

Drain terminals of the transistors MN1 and MN2 are connected to the gate terminals of counter transistors, respectively, thereby generating negative resistance necessary for oscillation. In the cross-coupled type oscillator, the drain terminals of the transistors MN1 and MN2 are used as output nodes and the two output nodes generate differential signals.

The capacitor C is connected between output terminals (output nodes) of the transistors MN1 and MN2. That is, a first terminal and a second terminal of the capacitor C are connected to the second terminal of the first transistor MN1 and the second terminal of the second transistor MN2, respectively.

The transmitting coil L_{S} has a first terminal and a second terminal, which are connected to the second terminal of the first transistor MN1 and the second terminal of the second transistor MN2, respectively, and a third terminal connected to a second power VDD. The transmitting coil L_{S} may be a center tap type inductor.

The transmitting coil L_{S} plays an important part for determining the oscillation frequency of the oscillator in cooperation with the capacitor C and also wirelessly transmits AC power outputted through the first and second transistors MN1 and MN2 to a receiving coil L_{R} of the power receiver.

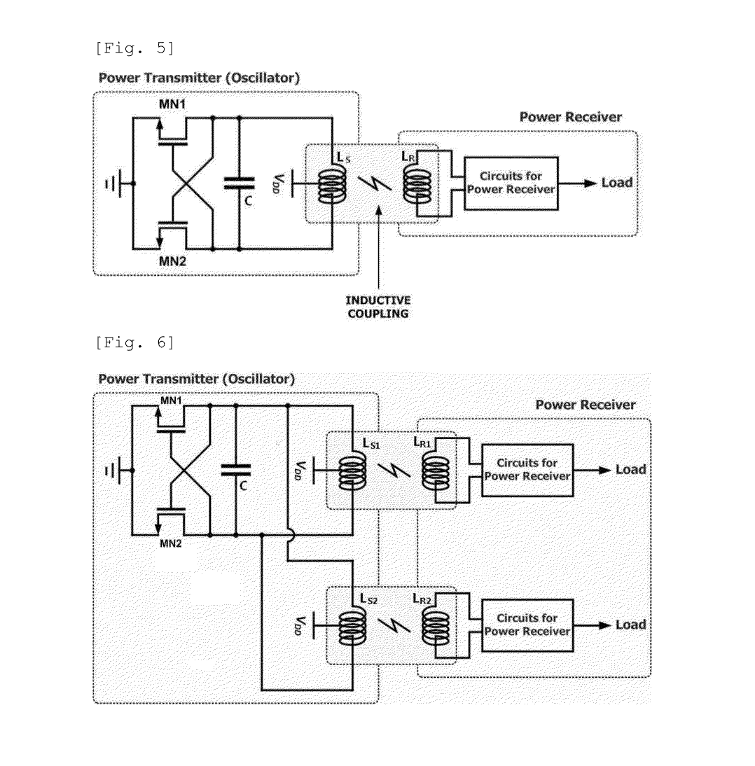

As described above, according to an embodiment of the present invention, there is no need for individually using an oscillator, a DC-AC converter, and a transmitting coil L2, as in (a) of FIG. 3 of the related art. In this embodiment, unlike that of FIG. 3, an existing DC-AC converter is not used, but an oscillator using an LC tank is used and the inductor L_{S} necessary for the oscillator is not only used to generate a resonance frequency, but used as a transmitting coil for wireless power transmission.

As described above, in an oscillator, an inductor is a necessary element and a transmitting coil is also necessary for wireless power transmission. However, the inductor and the coil are achieved in the same way and are their operation principles are also the same in terms of using a magnetic field.

Accordingly, an embodiment of the present invention, as the inductor L_{S} of the oscillator is used as a transmitting coil, the inductor of the oscillator determines the oscillation frequency of the oscillator and functions as a coil of wirelessly transmitting power. However, an oscillator is required to generate high output power and this can be achieved by changing the size of transistors.

As described above, compared with FIG. 3 of the related art, in the configuration of a power transmitter according to an embodiment of the present invention, a DC-AC converter is removed and the inductor L1 and the transmitting coil L2 of an oscillator are integrated into one coil L_{S}, so the area of the power transmitter in the entire chip decreases, thus reducing the manufacturing cost.

On the other hand, in an embodiment of the present invention, a capacitor may be added in the crossing paths in an oscillator, respectively. That is, a capacitor may be connected between the second terminal of the first transistor MN1 and the gate of the second transistor MN2 and a capacitor may be connected between the second terminal of the second transistor MN2 and the gate of the first transistor MN1. The capacitors in the crossing paths correspond to a DC block cap and prevent external DC power from being transmitted to the gates of the transistors. This configuration is available for other embodiments to be described below.

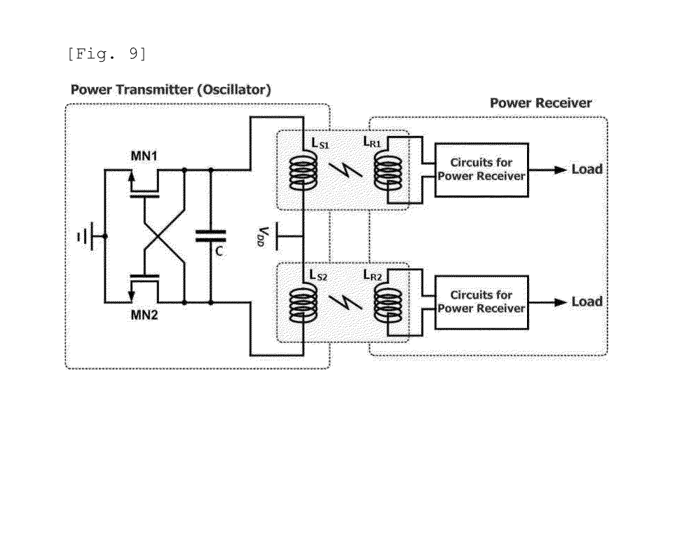

FIGS. 6 to 8 are modifications of FIG. 5. For the convenience of description, the transmitting coil L_{S} and the receiving coil L_{R} in FIG. 5 are referred to as a first transmitting coil L_{S1} and a first receiving coil L_{R1}, respectively. In FIGS. 6 to 8, there are provided a plurality of power receivers corresponding to the number of a plurality of transmitting coils, and for the convenience of description, those individual power receivers are set in one block in the figures.

In the modifications illustrated in FIGS. 6 to 8, the first terminal and the second terminal of at least one second transmitting coil are connected between the first terminal and the second terminal of the first transmitting coil L_{S1}, the transmitting coils are arranged in parallel, and a second power VDD is connected to the third terminal of the second transmitting coil, respectively. In brief, a plurality of transmitting coils is connected in parallel to one power transmitter. Accordingly, it is possible to wirelessly supply power to receiving coils in a plurality of power receivers corresponding to a plurality of transmitting coils, respectively.

In FIG. 6, two transmitting coils are connected in parallel to one power transmitter. Two transmitting coils L_{S1} and L_{S2} individually wirelessly transmit AC power outputted through the transistors MN1 and MN2 to each of the receiving coils L_{R1} and L_{R2} corresponding to two power receivers.

The configuration illustrated in FIG. 7 is expanded from the configuration illustrated in FIG. 6, in which four transmitting coils L_{S1}, L_{S2}, L_{S3}, and L_{S4} are connected in parallel to one power transmitter. The four transmitting coils L_{S1}, L_{S2}, L_{S3}, and L_{S4} individually wirelessly transmit AC power outputted by transistors to each of the receiving coils L_{R1}, L_{R2}, L_{R3}, and L_{R4} corresponding to four power receivers.

The configuration illustrated in FIG. 6 is arranged twice in FIG. 8, in which there are provided two power transmitters and two transmitting coils are connected to each of the power transmitter. In this configuration, similarly, there are four transmitting coils and the four transmitting coils L_{S1}, L_{S2}, L_{S3}, and L_{S4} can wirelessly transmit power to four receiving coils L_{R1}, L_{R2}, L_{R3}, and L_{R4}.

In those configurations, each of the transmitting coils wirelessly transmits power to each of the receiving coils of power receivers corresponding to their loads. Further, those configurations FIGS. 6 to 8 can be easily applied in the same way to configurations with two or, four or more power receivers.

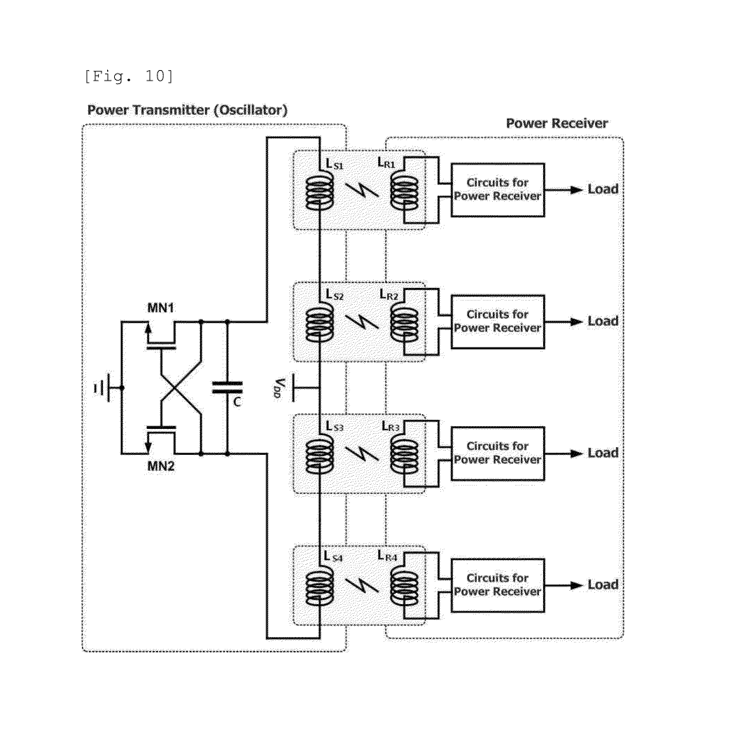

FIG. 9 is a diagram illustrating the configuration of a power transmitter equipped with a device for chip-to-chip wireless power transmission according to a second embodiment of the present invention. Referring to FIG. 9, a device for a chip-to-chip wireless power transmission according to a second embodiment of the present invention includes a first transistor MN1, a second transistor MN2, a capacitor C, and a coil transmitter.

First, in FIG. 9, the first transistor MN1 has a first terminal connected to a first power (for example, GND) and outputs a first output signal (positive output) through a second terminal.

The second transistor MN2, as in the first embodiment illustrated in FIG. 5, has a first terminal connected to the first power (for example, GND), a second terminal connected to a gate of the first transistor MN1, and a gate connected to the second terminal of the first transistor MN1, so it is cross-coupled to the first transistor MN1. The second transistor MN2 outputs a second output signal (negative output) with a phase opposite to that of the first output signal through the second terminal.

The capacitor C is also, as in the first embodiment, is connected between the output terminals of the transistors MN1 and MN2. That is, a first terminal and a second terminal of the capacitor C are connected to the second terminal of the first transistor MN1 and the second terminal of the second transistor MN2, respectively.

The difference between the second embodiment of FIG. 9 and the first embodiment of FIG. 5 is that there is provided not one, but a plurality of transmitting coils and they are connected in series. Further, the transmitting coils have not a tap type with three terminals, but a common inductor type with two terminals.

In FIG. 9, the coil transmitter has N (for example, N=2) transmitting coils connected in series, and a first terminal of a first transmitting coil and a second terminal of an N-th transmitting coil are connected to a second terminal of the first transistor MN1 and a second terminal of the second transistor MN2, respectively.

In the coil transmitter, a second power (for example, VDD) is connected to one selected from at least one node between the N transmitting coils. In FIG. 9, there is one node between two transmitting coils, so the second power is connected to the node.

The N (N=2 in FIG. 9) transmitting coils L_{S1} and L_{S2} wirelessly transmit AC power outputted through the first and second transistors MN1 and MN2 to N receiving coils L_{R1} and L_{R2} corresponding to N power receivers, respectively.

When there is a plurality of receiving units, transmitting unit require the same number of circuits, so the size of the entire system increases. However, in the configuration illustrated in FIG. 9, only one transmitting unit is sufficient for two receiving units, so the size of the entire system for chip-to-chip wireless power transmission is reduced, thereby reducing the manufacturing cost.

By providing one oscillator and arranging transmitting coils for wireless power transmission in series in a power transmitter, it is possible to achieve the effect that there are two transmitters for the power receiver. In this configuration, virtual grounding of differential signals is generated at the center portion (node) between the two transmitting coils, so power voltage of an oscillator can be supplied through the virtual grounding node.

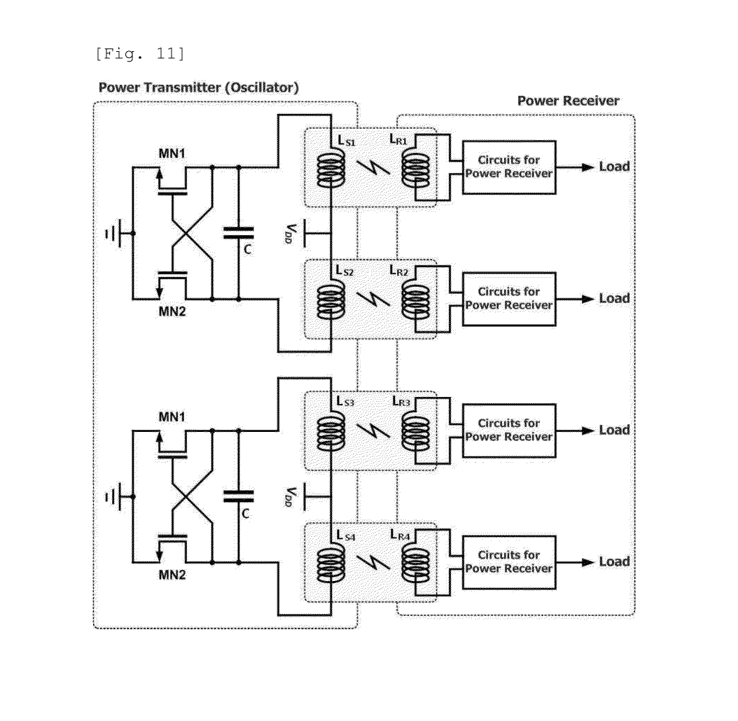

FIGS. 10 and 11 are modifications of FIG. 9. FIG. 10 illustrates a coil transmitter composed of four transmitting coils L_{S1}, L_{S2}, L_{S3}, and L_{S4} connected in series. In the example illustrated in FIG. 9, power is wirelessly transmitted two receiving units with one oscillator, but FIG. 10 illustrates an example that power is wirelessly transmitted to four receiving units with one oscillator.

In FIG. 10, four transmitting coils L_{S1}, L_{S2}, L_{S3}, and L_{S4} wirelessly transmit AC power outputted through the first and second transistors MN1 and MN2 to four receiving coils L_{R1}, L_{R2}, L_{R3}, and L_{R4}, respectively, which correspond to four power receivers.

However, the second power VDD is supplied to the node at the center of three nodes formed by the four transmitting coils L_{S1}, L_{S2}, L_{S3}, and L_{S4} (the node between the second and third transmitting coils of the first to fourth transmitting coils). That is, virtual grounding of differential signals are generated at the center portions of the four transmitting coils and power voltage of an oscillator can be supplied through the virtual grounding nodes.

As described above, in the second embodiment of the present invention, the N may be an even number and the second power may be connected to the node at the center of at least one node formed between the N transmitting coils. That is, the N can be further increased. In the same expanding ways illustrated in FIGS. 9 and 10, it is possible to wirelessly transmit power to two or, four or more receiving units with one oscillator.

There are provided two transmitters of FIG. 9 in FIG. 11. In the configuration of FIG. 11 power is supplied to four receivers by two transmitters, which is different from using one transmitter in FIG. 10.

Although it is possible to wirelessly supply power to four receivers using one transmitter, as in FIG. 10, inductors, that is, transmitting coils are formed on a chip and parasitic resistances due to the metal wires of the coils may function as a factor that limits the power conversion efficiency of the entire wireless power transmission system.

Accordingly, connecting four transmitting coils in series, as illustrated in FIG. 10, may achieve the same effects when four parasitic resistances of the coils are connected in series, so a resistive loss of AC power transmitted to the coils may be large.

The configuration of FIG. 11 is provided to solve this problem, and when there are four receiving units, power is wirelessly supplied from two transmitters to four receivers by the configuration of FIG. 9. This is another embodiment from the configuration illustrated in FIG. 10.

Obviously, the second embodiment of the present invention may be expansively applied to a chip-to-chip wireless power transmission system with four or more receiving units in the same way.

Comparing FIGS. 10 and 11, when the parasitic resistances of the metal wires of the transmitting coils are small, the complication and size of the entire system can be reduced by the way illustrated in FIG. 10. Further, the parasitic resistances of the metal wires of the transmitting coils are large, it is possible to attenuate efficiency reduction of the entire system due to the parasitic resistances of the transmitting coils by the way illustrated in FIG. 11.

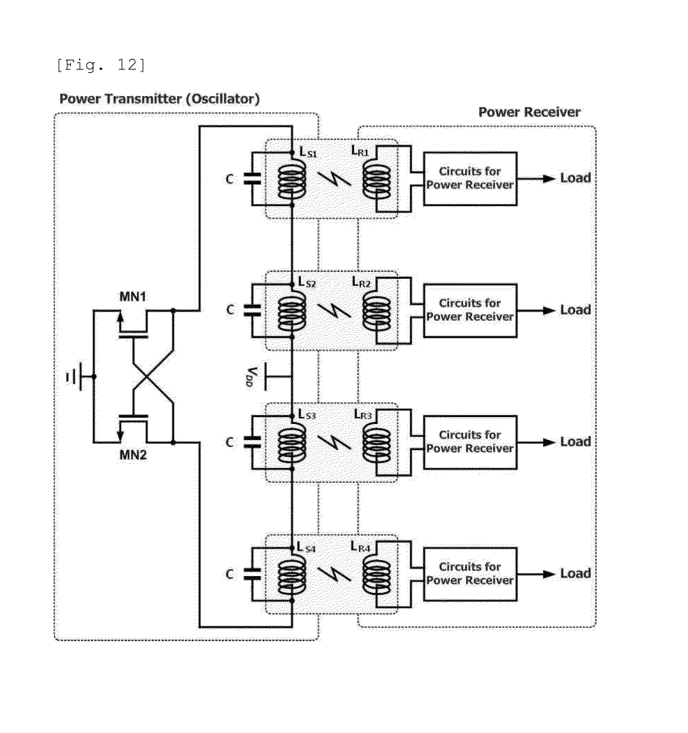

FIG. 12 is a diagram illustrating the configuration of a power transmitter equipped with a device for inter-chip wireless power transmission according to a third embodiment of the present invention.

Referring to FIG. 12, a device for a chip-to-chip wireless power transmission according to a third embodiment of the present invention includes a first transistor MN1, a second transistor MN2, a capacitor C, and a transmitting coil terminal.

First, in FIG. 12, the first transistor MN1 has a first terminal connected to a first power (for example, GND) and outputs a first output signal (positive output) through a second terminal.

The second transistor MN2, as in the first and second embodiments, has a first terminal connected to the first power (for example, GND), a second terminal connected to a gate of the first transistor MN1, and a gate connected to the second terminal of the first transistor MN1, so it is cross-coupled to the first transistor MN1. The second transistor MN2 outputs a second output signal (negative output) with a phase opposite to that of the first output signal through the second terminal.

In FIG. 9, the coil transmitter, as in the second embodiment, has N (for example, N=4) transmitting coils connected in series, and a first terminal of a first transmitting coil and a second terminal of an N-th transmitting coil are connected to a second terminal of the first transistor MN1 and a second terminal of the second transistor MN2, respectively. N is 4 in FIG. 12.

In the coil transmitter, a second power (for example, VDD) is connected to one selected from at least one node between the N transmitting coils. In FIG. 12, there are three nodes between four transmitting coils and the second power (for example, VDD) is connected to the middle node.

A capacitor is connected in parallel to each of the transmitting coils, unlike the previous embodiments. That is, four capacitors C are connected in parallel to the transmitting coils L_{S1}, L_{S2}, L_{S3}, and L_{S4}, respectively.

In the third embodiment as well, four transmitting coils L_{S1}, L_{S2}, L_{S3}, and L_{S4} wirelessly transmit AC power outputted through the first and second transistors MN1 and MN2 to four receiving coils L_{R1}, L_{R2}, L_{R3}, and L_{R4}, respectively, which correspond to four power receivers. Further, as in the second embodiment, the number N of the transmitting coils may be an even number, the second power may be connected to the node at the center of at least one nodes formed between the transmitting coils, and the circuit may be expanded.

In the configuration of FIG. 12, inductors and capacitors that determine the resonance frequency of an oscillator are formed in different ways. When inductors (functioning as transmitting coils as well) and capacitors that determine the resonance frequency are formed in the first and second embodiments, a plurality of inductors functioning as transmitting coils, which wirelessly supply power, is formed in the same number as the receiving units, but only one capacitor is shared. On the other hand, in the modification illustrated in FIG. 12, a plurality of capacitors is formed such that inductors and capacitors making pairs each have a resonance frequency, respectively. Obviously, power can be wirelessly supplied from one transmitter to a plurality of receivers in FIG. 12.

According to a device for chip-to-chip power transmission using an oscillator of the present invention, it is possible to reduce the size of the entire chip constituting a transmitter and reduce the manufacturing cost by removing a DC-AC converter from the transmitter. In addition, it is possible to preclude power from being consumed by a DC-AC converter, and since an inductor of an oscillator and a transmitting coil can be integrated, it is possible to reduce leakage of power consumed by passive elements and increase power transmission and conversion efficiency of the entire chip-to-chip wireless power transmission system.

As set forth above, according to exemplary embodiments of the invention, in the configuration of a power transmitter for chip-to-chip wireless power transmission, an oscillator is used instead of a DC-AC converter of the related art, so the complication and size of the circuit of the entire power transmitter can be reduced and the power conversion efficiency can be increased.

While the present invention has been illustrated and described in connection with the exemplary embodiments, it will be apparent to those skilled in the art that modifications and variations can be made without departing from the spirit and scope of the invention as defined by the appended claims.

1. A device for chip-to-chip wireless power transmission, which is provided to a power transmitter, the device comprising:
a first transistor that has a first terminal connected to a first power and outputs a first output signal through a second terminal;
a second transistor that has a first terminal connected to the first power, a second terminal connected to a gate of the first transistor, and a gate connected to the second terminal of the first transistor, and outputs a second output signal having a phase opposite to that of the first output signal through the second terminal;
capacitors that each have a first terminal and a second terminal connected to the second terminal of the first transistor and the second terminal of the second transistor, respectively; and
a transmitting coil that has a first terminal and a second terminal connected to the second terminal of the first transistor and the second terminal of the second transistor, respectively, a third terminal connected to a second power, and wirelessly transmits AC power outputted through the first and second transistor to a receiving coil of a power receiver.

2. The device of claim 1, wherein the transmitting coil and the receiving coil are a first transmitting coil and a first receiving coil,
the device further includes at least one second transmitting coil that has a first and a second terminal connected in parallel between the first terminal and the second terminal of the first transmitting coil, and a third terminal connected to the second power, respectively, and
the second transmitting coil wirelessly transmits the AC power to at least one second receiving coil corresponding to at least one power receiver, respectively.

3. A device for chip-to-chip wireless power transmission, which is provided to a power transmitter, the device comprising:
a first transistor that has a first terminal connected to a first power and outputs a first output signal through a second terminal;
a second transistor that has a first terminal connected to the first power, a second terminal connected to a gate of the first transistor, and a gate connected to the second terminal of the first transistor, and outputs a second output signal having a phase opposite to that of the first output signal through the second terminal;
capacitors that each have a first terminal and a second terminal connected to the second terminal of the first transistor and the second terminal of the second transistor, respectively; and
a coil transmitter that has N transmitting coils connected in series, in which a first terminal of a first transmitting coil and a second terminal of an N-th transmitting coil are connected to the second terminal of the first transistor and the second terminal of the second transistor, respectively, and a second power is connected to one node selected from at least one node formed between the transmitting coils,
wherein the N transmitting coils wirelessly transmit AC power outputted through the first and second transistors to N receiving coils corresponding to N power receivers, respectively.

4. A device for chip-to-chip wireless power transmission, which is provided to a power transmitter, the device comprising:
a first transistor that has a first terminal connected to a first power and outputs a first output signal through a second terminal;
a second transistor that has a first terminal connected to the first power, a second terminal connected to a gate of the first transistor, and a gate connected to the second terminal of the first transistor, and outputs a second output signal having a phase opposite to that of the first output signal through the second terminal;
a coil transmitter that has N transmitting coils connected in series, in which a first terminal of a first transmitting coil and a second terminal of an N-th transmitting coil are connected to the second terminal of the first transistor and the second terminal of the second transistor, respectively, and a second power is connected to one node selected from at least one node formed between the transmitting coils; and
N capacitors that are connected in parallel to the N transmitting coils, respectively,
wherein the N transmitting coils wirelessly transmit AC power outputted through the first and second transistors to N receiving coils corresponding to N power receivers, respectively.

5. The device of claim 3, wherein the N is an even number and the second power is connected to a node at the center of at least one node formed between the transmitting coils.

6. The device of claim 1, wherein the first power is a grounding power and the second power is larger than the first power.

7. The device of claim 1, further comprising:
a first capacitor connected between the second terminal of the first transistor and the gate of the second transistor; and
a second capacitor connected between the second terminal of the second transistor and the gate of the first transistor.

8. The device of claim 4, wherein the N is an even number and the second power is connected to a node at the center of at least one node formed between the transmitting coils.

9. The device of claim 2, wherein the first power is a grounding power and the second power is larger than the first power.

10. The device of claim 3, wherein the first power is a grounding power and the second power is larger than the first power.

11. The device of claim 4, wherein the first power is a grounding power and the second power is larger than the first power.

12. The device of claim 2, further comprising:
a first capacitor connected between the second terminal of the first transistor and the gate of the second transistor; and
a second capacitor connected between the second terminal of the second transistor and the gate of the first transistor.

13. The device of claim 3, further comprising:
a first capacitor connected between the second terminal of the first transistor and the gate of the second transistor; and
a second capacitor connected between the second terminal of the second transistor and the gate of the first transistor.

14. The device of claim 4, further comprising:
a first capacitor connected between the second terminal of the first transistor and the gate of the second transistor; and
a second capacitor connected between the second terminal of the second transistor and the gate of the first transistor.
